(19) United States
(12) Patent Application Publication
(10) Pub. No.: US 2025/0367595 A1
(43) Pub. Date: Dec. 4, 2025

(54) COMPRESSOR SYSTEM AND A METHOD OF CONTROLLING THE SAME

(71) Applicants: HYUNDAI MOTOR COMPANY, Seoul (KR); KIA CORPORATION, Seoul (KR)

(72) Inventors: Hae Jun Jeong, Hwaseong-si (KR); Yoon Geun Cho, Hwaseong-si (KR)

(73) Assignees: HYUNDAI MOTOR COMPANY, Seoul (KR); KIA CORPORATION, Seoul (KR)

(21) Appl. No.: 18/932,184

(22) Filed: Oct. 30, 2024

(30) Foreign Application Priority Data
May 30, 2024 (KR) 10-2024-0070617

(51) Int. Cl. B01D 53/26; B01D 53/04; B01D 53/047

(52) U.S. Cl. CPC B01D 53/261; B01D 53/0454; B01D 53/047; B01D 2257/80

(57) ABSTRACT

A compressor system includes a compressor configured to draw in intake air and produce compressed air in a compression mode of the compressor system and includes an adsorbent configured such that the compressed air passes through the adsorbent. The adsorbent can be regenerated by a regeneration mode of the compressor system. The system also includes an air tank configured to store the compressed air having passed through the adsorbent and a controller configured to determine a saturation degree of the adsorbent based on information on the intake air supplied to the compressor system or air discharged from the compressor system.

### CROSS-REFERENCE TO RELATED APPLICATION

This application claims under 35 U.S.C. § 119(a) the benefit of and priority to Korean Patent Application No. 10-2024-0070617, filed on May 30, 2024, the entire contents of which are incorporated herein by reference.

### TECHNICAL FIELD

The present disclosure relates to a compressor, and more particularly, to the regeneration of an adsorbent for a compressor.

### BACKGROUND

A compressor may produce compressed air by taking in and compressing outside air. Because moisture in air is condensed by a temperature difference, condensate water may be produced during a compression process. Because the condensate water may be frozen at a low temperature, which may damage components, the produced condensate water needs to be removed. Typically, the condensate water may be removed by using a cooler or adsorbent.

An adsorbent is mainly used in a compressor with a comparatively small size, such as a compressor for a vehicle. The adsorbent refers to a material, such as silica gel, that has many pores in crystals and thus has the property of adsorbing water. However, because the adsorbent is saturated as the adsorbent is used, the adsorbent needs to be dehumidified or regenerated for reuse.

For example, moisture in the adsorbent may be removed by evaporating the moisture by heating the adsorbent to a certain temperature. As another example, the adsorbent may be dehydrated by passing dry air through the adsorbent.

The above information disclosed in this Background section is only to enhance understanding of the background of the disclosure. Therefore, the Background section may contain information that does not form the prior art that is already known to a person of ordinary skill in the art.

### SUMMARY

The technical concepts of the present disclosure have been made in an effort to solve the above-mentioned problems. Objects of the present disclosure are to provide a compressor system and a method of controlling the same. The system and the method are capable of preventing inefficiency caused by a waste of compressed air and a deterioration in regeneration efficiency by considering states of atmospheric air and an adsorbent.

The technical concepts of the present disclosure have also been made in an effort to provide a compressor system and a method of controlling the same that are capable of preventing damage to components of the compressor system caused by the occurrence of condensate water.

The objects of the present disclosure are not limited to the above-mentioned objects. Other objects, which are not mentioned above, may be more clearly understood from the following description by those with ordinary skill in the art to which the present disclosure pertains.

The features of the present disclosure for achieving the above-mentioned objects and for carrying out the characteristic functions of the present disclosure are described below.

In one aspect, the present disclosure provides a compressor system including a compressor configured to draw in intake air and to produce compressed air in a compression mode of the compressor system. The compressor system also includes an adsorbent configured such that the compressed air passes through the adsorbent. The adsorbent is regenerable by a regeneration mode of the compressor system. The compressor system also includes an air tank configured to store the compressed air having passed through the adsorbent as stored air. The compressor system further includes a controller configured to determine a saturation degree of the adsorbent based on information on the intake air supplied to the compressor system or discharge air discharged from the compressor system.

In another aspect, the present disclosure provides a method of controlling a compressor system. The method includes: collecting, by a controller, state information of the compressor system; determining, by the controller, at least one of a performance time point or a stop time point of a regeneration mode of the compressor system based on the state information; and performing or stopping, by the controller, the regeneration mode of the compressor system in response to determining that the performance time point or the stop time point is reached.

The present disclosure provides a compressor system and a method of controlling the same that are capable of preventing the inefficiency caused by a waste of compressed air and the deterioration in regeneration efficiency by taking into account the of states of atmospheric or intake air and an adsorbent.

The present disclosure provides a compressor system and a method of controlling the same that are capable of preventing damage to the components of the compressor system caused by the occurrence of condensate water.

The effects of the present disclosure are not limited to the above-mentioned effects. Other effects, which are not mentioned above, should be more clearly understood by those of ordinary skill in the art from the following description.

Other aspects and embodiments of the disclosure are discussed herein.

It should be understood that the terms “vehicle” or “vehicular” or other similar term as used herein are inclusive of motor vehicles in general. Such motor vehicles may encompass passenger automobiles including sports utility vehicles (SUVs), buses, trucks, various commercial vehicles, watercraft including a variety of boats and ships, aircraft, and the like. Such motor vehicles may also include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example vehicles that are both gasoline-powered and electric-powered.

The above and other features of the disclosure are discussed herein.

### BRIEF DESCRIPTION OF THE DRAWINGS

The above and other features of the present disclosure are described in detail with reference to certain embodiments thereof illustrated in the accompanying drawings, which are given hereinbelow by way of illustration only, and thus are not limitative of the present disclosure, and wherein:

FIG. 1 is an example configuration of an air cleaning system of a vehicle;

FIG. 2 is an example of the vehicle;

FIG. 3 is a configuration of a compressor system according to an embodiment of the present disclosure;

FIG. 4 is a view illustrating a compressor system according to an embodiment of the present disclosure;

FIG. 5A is a view illustrating a movement route or flow path of air in a compression mode of a compressor system according to an embodiment of the present disclosure;

FIG. 5B is a view illustrating a movement route or flow path of air in a regeneration mode of a compressor system according to an embodiment of the present disclosure;

FIG. 6 is a flowchart of control in a compression mode of a compressor system according to an embodiment of the present disclosure;

FIG. 7 is a flowchart for determining whether to enter into a regeneration mode of the compression mode in the embodiment in FIG. 6;

FIG. 8 is a view illustrating a distributor connected to an air tank of a compressor system according to an embodiment of the present disclosure;

FIG. 9 is a control flowchart in a regeneration mode of a compressor system according to an embodiment of the present disclosure; and

FIG. 10 is a flowchart for determining whether to cease the regeneration mode of the compression mode in the embodiment in FIG. 9.

It should be understood that the appended drawings are not necessarily to scale, presenting a somewhat simplified representation of various features illustrative of the basic principles of the present disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawings.

### DETAILED DESCRIPTION

Hereinafter, reference is made in detail to various embodiments of the present disclosure, examples of which are illustrated in the accompanying drawings and described below. While the technical concepts of the present disclosure are described in conjunction with various embodiments, it should be understood that the present description is not intended to limit the disclosure to those embodiments. On the contrary, the present disclosure is intended to cover not only the disclosed embodiments, but also various alternatives, modifications, equivalents, and other embodiments, which may be included within the spirit and scope of the disclosure as defined by the appended claims.

Meanwhile, the terms, such as “first” and/or “second” in the present disclosure may be used to describe various elements, but these elements should not be limited by these terms. These terms are used only for the purpose of distinguishing one element from other elements. For example, without departing from the scope according to the concepts of the present disclosure, a first element may be referred to as a second element, and similarly, the second element may also be referred to as the first element.

When one element is described as being “coupled” or “connected” to another element, it should be understood that one element can be coupled or connected directly to another element, and an intervening element can also be present between the elements. When one element is described as being “coupled directly to” or “connected directly to” another constituent element, it should be understood that no intervening element is present between those elements. Other expressions, such as, “between” and “just between” or “adjacent to” and “directly adjacent to,” for explaining a relationship between elements, should be interpreted in a similar manner.

Like reference numerals indicate like elements throughout the specification. Meanwhile, the terms used in the present specification are for explaining embodiments, not for limiting the present disclosure. Unless particularly stated otherwise in the present specification, a singular form also includes a plural form. The terms “comprise (include, have)” and/or “comprising (including, having)” and variations thereof used in the specification are intended to specify the presence of the mentioned elements, steps, operations, and/or elements. Such terms do not exclude the presence or addition of one or more other elements, steps, operations, and/or elements.

Hereinafter, the present disclosure is described in detail with reference to the accompanying drawings. When a component, device, element, or the like of the present disclosure is described as having a purpose or performing an operation, function, or the like, the component, device, element, or the like should be considered herein as being “configured to” meet that purpose or to perform that operation or function. Each component, device, element, or the like, and particularly the controller, may separately embody or be included with a processor and a memory, such as a non-transitory computer readable media, as part of the apparatus.

Compressors configured to produce compressed air are being applied to various fields. For example, in vehicles, compressors have been mainly used for air suspensions. Recently, the compressors have been also applied to sensor cleaning systems for cleaning environmental sensors for autonomous driving of vehicles.

Various environmental sensors capable of detecting surrounding environments are mounted in the vehicle to implement a driver assistance system or autonomous driving. Because these environmental sensors are mounted on outer portions of the vehicle, these environmental sensors may be easily contaminated by foreign substances, such as dust, rainwater, and the like. The environmental sensors need to be maintained at a predetermined level or higher of cleanliness to maintain the necessary performance. Therefore, such vehicles are equipped with a sensor cleaning system for cleaning the environmental sensor or sensors when an environmental sensor is contaminated.

Specifically, such a sensor cleaning system may be an air cleaning system using a compressor. The air cleaning system is configured to clean the environmental sensor by spraying compressed air, which is compressed by the compressor, onto the environmental sensor.

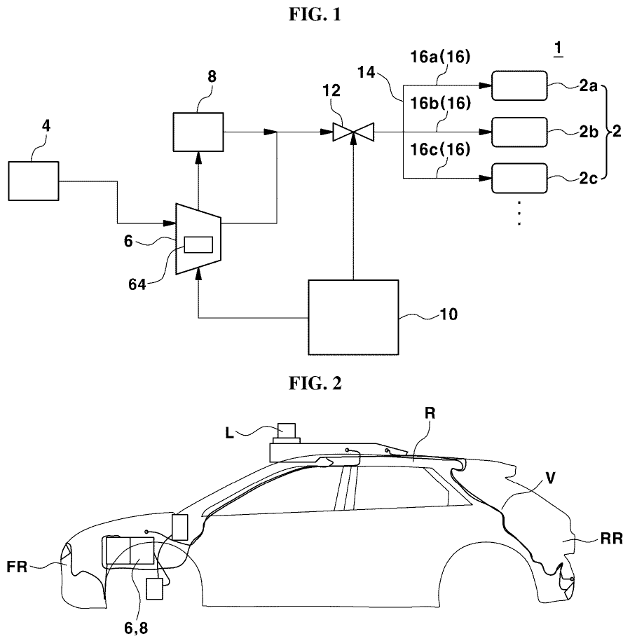

FIG. 1 illustrates an example of an air cleaning system 1 provided in a vehicle. The air cleaning system 1 is configured to clean environmental sensors 2a, 2b, and 2c (collectively, and for convenience of description, the environmental sensor 2) by using compressed air. The environmental sensor 2 may include a sensing device, such as a lidar (L) sensor, a radar sensor, or a camera. As illustrated in FIG. 2, the environmental sensors 2 may be disposed on a front portion FR, a rear portion RR, a side portion, a roof R, and the like of a vehicle V. Three environmental sensors are illustrated and described in the drawings and specification, but the present disclosure is not limited to any specific number of environmental sensors, and the number of environmental sensors may be greater or fewer.

The intake air, i.e., atmospheric or outside air, may be filtered by an air filter 4 disposed in the vehicle V and is introduced into a compressor 6. The air, i.e., compressed air, compressed by the compressor 6 may be sprayed onto the surface of the environmental sensor 2, thereby removing foreign substances on the environmental sensor 2. In addition, the air cleaning system 1 includes an air tank 8. The air tank 8 may be filled with air, i.e., stored air, compressed by the compressor 6 or air supplied from an external device. The air stored in the air tank 8 may be used to clean the environmental sensor 2.

A controller 10 of the air cleaning system 1 is configured to operate a valve 12, e.g., a solenoid valve for each preset period or in a preset situation in which contamination of the environmental sensor 2 is detected. Therefore, the controller 150 may spray the compressed air to the respective environmental sensors 2 from the compressor 6 or the air tank 8, thereby cleaning the environmental sensor 2. A distributor 14 may be provided on or integrated with the valve 12 and distribute the compressed air through nozzles 16 (16a, 16b, and 16c) respectively provided for the plurality of environmental sensors 2.

The compressor 6 includes a dryer 64. The dryer 64 is configured to remove moisture present in the compressed air compressed by the compressor 6. In an embodiment, the dryer 64 includes a regenerable adsorbent to remove moisture from the compressed air passing through the dryer 64. The adsorbent refers to a material that has many pores in its crystals and thus has the property of absorbing water. As an example, the adsorbent may include silica gel.

As described above, moisture needs to be periodically removed from the adsorbent to continuously use the adsorbent in the dryer 64, which adopts the adsorption method. In an air suspension system of a vehicle, since the amount of intake air drawn into the compressor and the amount of air discharged by the compressor are equal to each other, there is no great difficulty in regenerating the adsorbent. However, in a sensor cleaning system, because most of the drawn air discharged through the nozzles to clean the environmental sensors is released to an environment, i.e., the outside, the amount of air discharged by the compressor is less than the amount of intake air.

Therefore, the regeneration performed by the compressor in the sensor cleaning system in the related art is performed by directing the compressed air in the air tank toward the adsorbent. For example, if the compressor fills the air tank with air up to a predetermined pressure, e.g., 10 bar, the air stored in the air tank is supplied to the adsorbent until the pressure in the air tank becomes a predetermined pressure, e.g., 9 bar. As another example, if the compressor has produced compressed air for a predetermined time, e.g., 60 seconds, the air stored in the air tank is supplied to the adsorbent until the pressure in the air tank becomes a predetermined pressure, e.g., 5 bar.

However, this regeneration process in the related art is inefficient because the regeneration process is performed unconditionally without accounting for the amount of water vapor in the atmospheric air or the actual vapor saturation degree of the adsorbent. For example, in the related art, the regeneration is immediately performed when a predetermined operating time point, i.e., operating time, is reached without considering whether the adsorbent is saturated even in a dry environment in which the amount of moisture in the atmospheric air is small. If the adsorbent is regenerated in an unsaturated state, the regeneration efficiency may deteriorate, which may cause the compressed air to be wasted. Moreover, in the related art, whether the adsorbent is saturated is not considered even in a humid environment (e.g., caused by rain) where a considerable amount of moisture is present in the atmosphere. The regeneration is not performed when a predetermined regeneration time point is not reached. Condensate water is produced when the regeneration is not performed even though the adsorbent is saturated. Also, the condensate water is highly likely to damage components, such as a hose, a distributor, and a nozzle, through which the compressed air flows.

Accordingly, the present disclosure provides a compressor system and a method of controlling the same that are capable of determining whether the adsorbent is required to be regenerated. The system and method do so by calculating the amount of moisture contained in the adsorbent based on an atmospheric state and an operating state of the compressor system. The system and method of the present disclosure may prevent damage to components caused by the occurrence of condensate water and efficiently operate without compressed air that goes wasted. Additionally, the system and method of the present disclosure may enable continuous sensor cleaning in the event of rainfall and reduce costs and weight of the compressor.

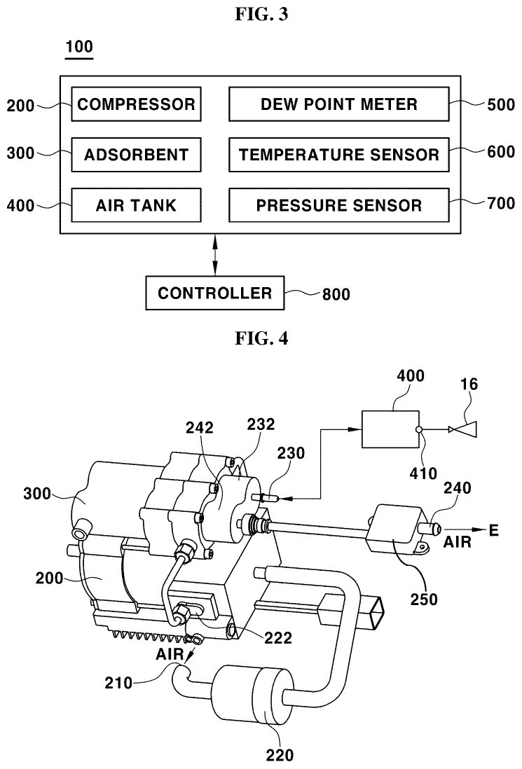

As illustrated in FIGS. 3 and 4, according to the present disclosure, a compressor system 100 includes a compressor 200, an adsorbent 300, and an air tank 400.

The compressor 200 may produce compressed air. The compressor 200 may take in air, i.e., intake air or outside air, and compress the air taken in to produce compressed air. The intake air may be introduced into the compressor 200 through an inlet 210 of the compressor 200. In an embodiment, the compressor system 100 includes an intake filter 220. For example, the intake filter 220 may be disposed downstream of the inlet 210 with respect to an introduction direction of the intake air. The air filtered by the intake filter 220 may be compressed by the compressor 200.

The compressed air produced by the compressor 200 is configured to pass through the adsorbent 300. The adsorbent 300 is a crystalline porous material and has a property of absorbing moisture. Therefore, moisture may be removed from the compressed air passing through the adsorbent 300. For example, as in the embodiment illustrated in FIG. 4, the compressor 200 and the adsorbent 300 may be integrated. In another example, the compressor 200 and the adsorbent 300 may be separately provided and configured to fluidly communicate with each other.

The air tank 400 may be filled with the compressed air passing through the adsorbent 300. The air tank 400 may be supplied with the compressed air through an inlet/outlet passageway or access passage 230 of the compressor 200. In an example, the compressed air stored in the air tank 400, i.e., stored air, may be used to clean the environmental sensor 2 by operation of the valve 12, as in the embodiment in FIG. 1.

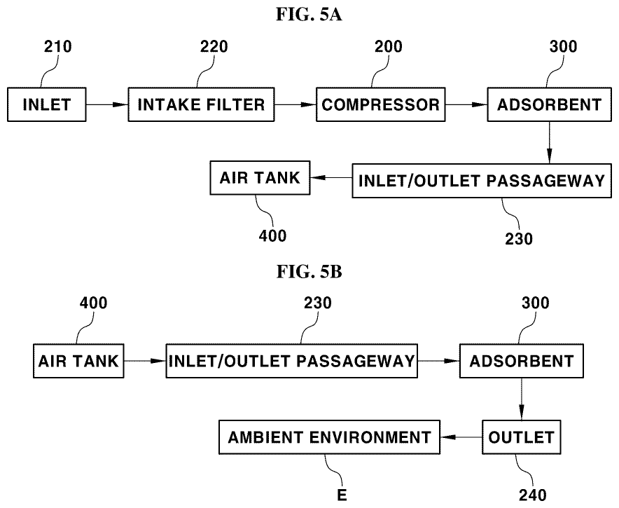

As illustrated in FIG. 5A, in a compression mode of the compressor 200, the intake air may flow to the air tank 400 through the inlet 210, the intake filter 220, the compressor 200, and the adsorbent 300. As used herein, the compression mode refers to a mode in which the compressor 200 draws in outside air and produces compressed air, and the compressed air, from which moisture is removed by the adsorbent 300, is stored in the air tank 400.

On the contrary, as illustrated in FIG. 5B, in a regeneration mode of the compressor 200, the air is discharged to an ambient environment E, i.e., discharge air, through the air tank 400 and the adsorbent 300. As used herein, the regeneration mode refers to an operating mode of the compressor system 100 in which the adsorbent 300 is dehydrated as dry air in the air tank 400 passes through the adsorbent 300 and then is discharged to the ambient environment E.

In the regeneration mode, the compressed air in the air tank 400, i.e., the stored air, may be directed toward the adsorbent 300. For example, the compressed air in the air tank 400 may be directed toward the adsorbent 300 through the access passage 230. In the present embodiment, the compressed air produced by the compressor 200 may be directed toward the air tank 400 through the access passage 230, and the compressed air in the air tank 400 may be directed toward the adsorbent 300 from the air tank 400 through the access passage 230.

The compressed air, which has flowed or passed to the adsorbent 300 from the air tank 400 and has dried the adsorbent 300, may be discharged to the ambient environment E through an outlet 240 of the compressor 200. In an embodiment, a silencer 250 may be mounted at the outlet 240. Because the compressed air, which has been used to regenerate the adsorbent 300, is discharged to the ambient environment E still at a high pressure and velocity, noise may be generated while the compressed air is discharged. The silencer 250 may reduce this noise.

In an embodiment, valves 232 and 242 may be provided in the access passage 230 and the outlet 240, respectively. As a non-restrictive example, the valves 232 and 242 may be solenoid valves. In the regeneration mode, when both the valve 232 in the access passage 230 and the valve 242 in the outlet 240 are opened, the compressed air or stored air may be discharged to the outlet 240 from the air tank 400 via the adsorbent 300. In an example, a one-way check valve 222 may be installed between the compressor 200 and the adsorbent 300 so that the compressed air discharged through the outlet 240 does not reversely flow toward the compressor 200 or the inlet 210 in the regeneration mode.

According to an embodiment of the present disclosure, the compressor system 100 includes one or more dew point meters or sensors 500. The dew point meters 500 may measure a dew point temperature of air. The dew point temperature refers to a temperature at which condensation of air is initiated when the air containing vapor is cooled. Once the dew point temperature is known, the amount of water vapor in the air may be acquired using a saturated water vapor curve, a saturated water vapor table, or a psychrometric chart.

The dew point meters 500 may include a meter that measures a dew point temperature of the intake air introduced into the inlet 210 of the compressor 200. Additionally, the dew point meters 500 may include a meter that measures the dew point temperature of the compressed air or stored air discharged through the outlet 240 in the regeneration mode. For example, the dew point meters 500 may include an inlet dew point meter 500a and an outlet dew point meter 500b, each of which is installed in the inlet 210 and the outlet 240, respectively. According to an embodiment, the inlet dew point meter 500a may be integrated with the intake filter 220. In an embodiment, the outlet dew point meter 500b may be integrated with the silencer 250. In addition, the dew point meters 500 may include a meter that measures the dew point temperature of the compressed air or stored air in the air tank 400. In an example, the dew point meter 500 may include a tank dew point meter 500c installed in the air tank 400.

The compressor system 100 may include a temperature sensor 600 and a pressure sensor 700. The temperature sensor 600 is configured to measure a temperature of the compressed or stored air in the air tank 400. The pressure sensor 700 is configured to measure a pressure of the compressed or stored air in the air tank 400.

According to an embodiment of the present disclosure, the compressor system 100 further includes a controller 800. The controller 800 may control an operation of the compressor system 100. According to an embodiment, the controller 800 may be provided as one or more integrated controllers capable of controlling both the air cleaning system 1 and the compressor system 100. According to another embodiment, the controller 800 may include one or more controllers configured to control the air cleaning system 1 and one or more controllers configured to control the compressor system 100. These separate controllers may communicate with one another.

The controller 800 may be configured to communicate with the elements of the compressor system 100 to collect information in real time. In an embodiment, the controller 800 may collect a dew point temperature (hereinafter, referred to as an inlet dew point temperature Dᵢₙ) of intake air at the inlet 210 from the inlet dew point meter 500a. In an embodiment, the controller 800 may collect a dew point temperature (hereinafter, referred to as an outlet dew point temperature Dₒᵤₜ) of discharge air discharged through the outlet 240 from the outlet dew point meter 500b. In an embodiment, the controller 800 may collect state information on the air tank 400. For example, the state information on the air tank 400 may include a dew point temperature, a temperature, and a pressure of the compressed air or stored in the air tank 400. To this end, the controller 800 may collect a tank dew point temperature Dₜ of the stored air in the air tank 400 that is measured by the tank dew point meter 500c. Also, the controller 800 may acquire a temperature Tₜ of the stored air in the air tank 400, which is measured by the temperature sensor 600, and a pressure Pₜ of the stored air in the air tank 400 that is measured by the pressure sensor 700. In addition, the controller 800 may acquire the amount of air consumed from the air tank 400. For example, the mass of air consumed in the air tank 400 may be calculated by using a spray time tₛ for which the nozzle 16 in the embodiment in FIG. 1 sprays the compressed air. For example, the spray time tₛ may be equal to an opening time of the valve 12. In an embodiment, the controller 800 may receive an operational signal of the compressor 200. Based on the operational signal of the compressor 200, the controller 800 may determine whether the compressor 200 is in the compression mode or the regeneration mode.

In an embodiment, the controller 800 includes preset input information. As a non-restrictive example, the input information stored in the controller 800 may include a volume V1 of the air tank 400.

Based on the collected information, the controller 800 may determine whether to place the compressor system 100 in the compression mode or the regeneration mode. To this end, the controller 800 may perform various types of computation based on the collected information. Specifically, the controller 800 may calculate, in real time, the amount of moisture in the adsorbent 300 and the mass of water vapor contained in the adsorbent 300 and may perform or stop the regeneration mode based on the amount of moisture in the adsorbent 300.

According to an embodiment of the present disclosure, a regeneration time point, i.e., regeneration time, of the adsorbent 300 or the entry into the regeneration mode may be determined during the compression mode of the compressor system 100.

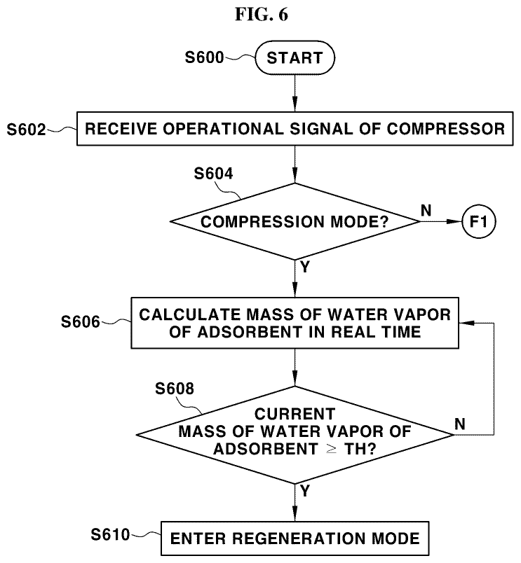

As in the embodiment illustrated in FIG. 6, at operation S600, the control for determining the time point for entering or stopping the regeneration mode of the compressor system 100 is initiated.

At operation S602, the controller 800 may receive an operational signal of the compressor 200 from the compressor 200. Based on the operational signal, the controller 800 may identify which operating state the compressor system 100 is placed in.

At operation S604, the controller 800 checks the operating mode of the compressor system 100. Specifically, the controller 800 may receive the operational signal from the compressor 200 such that the controller 800 may determine whether the compressor system 100 is in the compression mode or the regeneration mode. Based on the operational signal received from the compressor 200, the controller 800 performs operations S606 and steps subsequent to operation S606 when it is determined that the compressor system 100 is in the compression mode (YES at operation S604). On the contrary, the controller 800 may perform steps subsequent to F1 in FIG. 9 in response to determining that the compressor system 100 is in the regeneration mode (NO at operation S604).

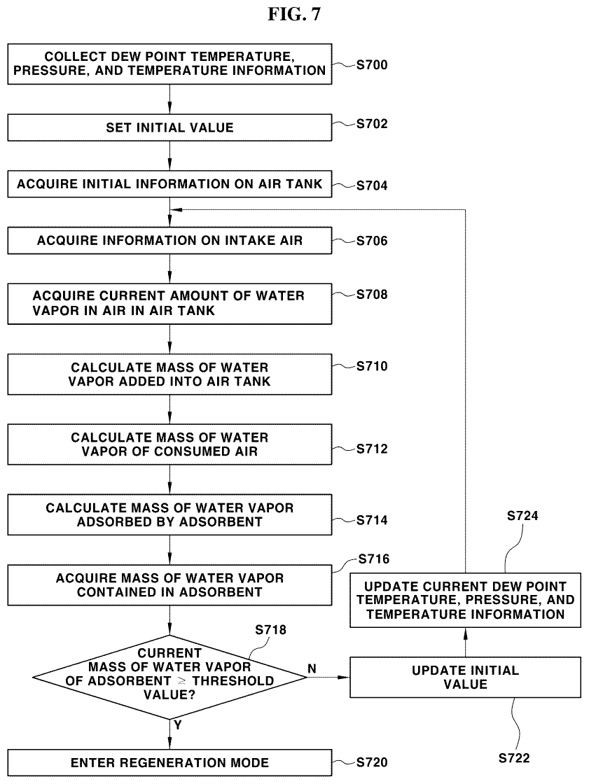

With continued reference to FIG. 6, the controller 800 is configured to calculate, in real time, the saturation degree of the adsorbent 300 or the mass F_{TOT} of water vapor contained in the adsorbent 300 in response to determining that the compressor system 100 is in the compression mode at operation S606. The mass F_{TOT} of water vapor of the adsorbent 300 may be determined based at least partially on the dew point temperature measured by the dew point meter 500, the pressure measured by the pressure sensor 700, and the temperature measured by the temperature sensor 600. A detailed calculation process is described with reference to FIG. 7 below.

With continued reference to FIG. 6, the controller 800 is configured to compare the real-time mass F_{TOT} of water vapor of the adsorbent 300 with a threshold value TH at operation S608. The threshold value TH refers to the maximum mass of water vapor that may be adsorbed by the adsorbent 300. When it is determined that the real-time mass F_{TOT} of water vapor of the adsorbent 300 is equal to or greater than the threshold value TH (YES at operation S608), the controller 800 allows the compressor 200 to operate in the regeneration mode at operation S610. When it is determined that the mass F_{TOT} of water vapor of the adsorbent 300 is less than the threshold value TH (NO at operation S608), the controller 800 may allow the compressor 200 to operate in the compression mode. Then the controller 800 may go back to operation S606 and continuously calculate, in real time, the mass F_{TOT} of water vapor of the adsorbent 300.

With reference to FIG. 7, according to an embodiment of the present disclosure, a process of calculating the saturation degree of the adsorbent 300 or the mass F_{TOT} of water vapor contained in the adsorbent 300 may be performed as follows.

The controller 800 collects measurement information from the dew point meters 500, the temperature sensor 600, and the pressure sensor 700 at operation S700. The controller 800 may collect, in real time, the inlet dew point temperature Dᵢₙ, the outlet dew point temperature Dₒᵤₜ, the tank dew point temperature Dₜ of the compressed or stored air in the air tank 400, the pressure Pₜ of the air in the air tank 400, and the temperature Tₜ of the air in the air tank 400.

At operation S702, the controller 800 is configured to set an initial value based on the measurement information received at operation S700. For example, the controller 800 may set the initial mass F₀ of water vapor currently contained in the adsorbent 300 to 0, set an initial tank pressure Pₜ₀ to the pressure Pₜ of the air in the air tank 400 received at operation S700, set an initial tank temperature Tₜ₀ to the temperature Tₜ of the air in the air tank 400 received at operation S700, and set an initial tank dew point temperature Dₜ₀ to the tank dew point temperature Dₜ of the air in the air tank 400 received at operation S700.

At operation S704, the controller 800 is configured to acquire initial information on the air tank 400. The initial information on the air tank 400 may refer to information made before new intake air is introduced into the inlet 210 of the compressor 200, i.e., current state information on the air tank 400. The initial information on the air tank 400 may include the initial mass B₀ of compressed or stored air in the air tank 400, the initial amount D₀ of water vapor in air in the air tank 400, and the initial mass H₀ of water vapor in the air tank 400.

Specifically, the controller 800 may calculate the initial mass B₀ of air in the air tank 400. The initial mass B₀ of air may be acquired by applying the initial tank pressure Pₜ₀, the initial tank temperature Tₜ₀, and the volume V1 of the air tank 400 to Equation 1. The amount of change in mass, i.e., the initial mass B₀ of air, may be calculated by using the ideal gas equation using Equation 1.

$${B}_{0} = \frac{{P}_{t 0} \times V 1}{R \times {T}_{t 0}} \qquad [ Equation 1 ]$$

The controller 800 may obtain the initial amount D₀ of water vapor in air within the air tank 400. Specifically, the controller 800 may determine the initial amount D₀ of water vapor based on the initial tank dew point temperature Dₜ₀. The controller 800 may include the saturated water vapor curve in the form of a map or lookup table and acquire the initial amount D₀ of water vapor in air from the saturated water vapor curve by using the initial tank dew point temperature Dₜ₀.

The controller 800 may calculate the initial mass H₀ of water vapor in the air tank 400 based on the initial mass B₀ of air and the initial amount D₀ of water vapor in air. Specifically, the initial mass H₀ of water vapor may be obtained by the product of the initial amount D₀ of water vapor in air and the initial mass B₀ of air.

At operation S706, the controller 800 is configured to acquire information on the intake air drawn into the compressor system 100. In other words, the intake air may mean air newly added to the compressor system 100. The information on the intake air may include the amount A of water vapor of the intake air before the adsorption, the mass B of intake air, and the mass C of water vapor of the intake air before the adsorption.

Specifically, the controller 800 is configured to obtain the amount A of water vapor of the intake air taken into the compressor system 100. The amount A of water vapor of the intake air may be determined based on the inlet dew point temperature Dᵢₙ. The controller 800 may acquire the amount A of water vapor of the intake air, which corresponds to the inlet dew point temperature Dᵢₙ, from the saturated water vapor curve.

Additionally, the controller 800 may calculate the mass B of intake air. The mass B of intake air may be acquired based on the mass B₁ of stored air stored in the air tank 400 of the mass B of intake air and the mass B₂ of consumed air consumed in the mass B of intake air.

The mass B₁ of stored air may be determined based on the initial tank pressure Pₜ₀, the initial tank temperature Tₜ₀, the current pressure Pₜ, and the current temperature Tₜ. Specifically, the controller 800 may determine the mass B₁ of stored air by relating the initial tank pressure Pₜ₀, the initial tank temperature Tₜ₀, the current pressure Pₜ, and the current temperature Tₜ based on Equation 2. Put differently, the mass B₁ of stored air may be calculated by using the ideal gas equation (PV=mRT, where P is pressure, V is volume, m is mass, R is gas constant, and T is temperature).

$${B}_{1} = \frac{{P}_{t} \times V 1}{R \times {T}_{t}} - \frac{{P}_{t 0} \times V 1}{R \times {T}_{t 0}} \qquad [ Equation 2 ]$$

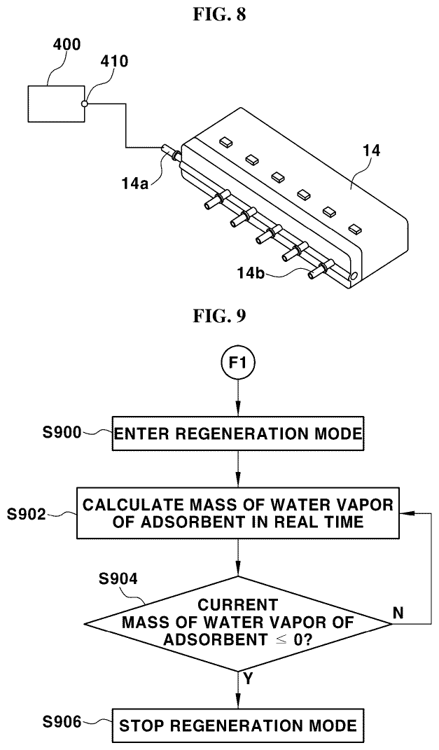

The controller 800 may determine the mass B₂ of consumed air consumed in the air tank 400 of the mass B of intake air. For example, the mass B₂ of consumed air may be the mass of air sprayed from the nozzle 16. The mass B₂ of consumed air may be determined by using characteristics of the flow choked in an outlet port 14b of a distributor 14. As illustrated in FIG. 8, the compressed air is introduced into an inlet port 14a of the distributor 14 from an outlet 410 of the air tank 400. The inlet port 14a is configured to fluidly communicate with a plurality of outlet ports 14b of the distributor 14 that may be opened or closed. A mass flow rate \dot{m} in each of the outlet ports 14b may be determined using Equation 3, and the mass B₂ of consumed air may be calculated by multiplying the mass flow rate \dot{m} by a spray time for each of the outlet ports 14b or a spray time tₛ of the nozzle 16 connected to each of the outlet ports 14b.

$$\dot{m} = \frac{S \cdot {P}_{t}}{\sqrt{{T}_{t}}} \sqrt{\frac{γ}{R}} {( \frac{γ + 1}{2} )}^{- \frac{γ + 1}{2 ( γ - 1 )}} \qquad [ Equation 3 ]$$

Here, S represents a cross-sectional area of the outlet port 14b, and γ represents a specific heat ratio (1.4 may be used because a value for air is not greatly changed in accordance with a temperature). According to the present disclosure, because the compressed air may be supplied to the nozzle 16 from the air tank 400 even when the compressor system 100 is in the compression mode or the regeneration mode, the mass B₂ of consumed air may also be considered at the time of calculating the amount of moisture in the adsorbent 300.

As shown in Equation 4, the controller 800 may calculate the mass B of intake air of the intake air by adding up the calculated mass B₁ of stored air and the calculated mass B₂ of consumed air.

$$B = {B}_{1} + {B}_{2} \qquad [ Equation 4 ]$$

The controller 800 may acquire the mass C of water vapor of the intake air before the adsorption before the intake air passes through the adsorbent 300. As shown in Equation 5, the mass C of water vapor of the intake air before the adsorption may be calculated by multiplying the amount A of water vapor of the intake air and the mass B of intake air of the intake air.

$$C = A \times B \qquad [ Equation 5 ]$$

At operation S708, the controller 800 is configured to acquire the current amount D of water vapor in the air tank 400. The controller 800 may acquire the current amount D of water vapor in the air tank 400 from the saturated water vapor curve based on the tank dew point temperature Dₜ measured by the tank dew point meter 500c.

At operation S710, the controller 800 is configured to compute the additional mass H of water vapor added into the air tank 400. The controller 800 may acquire the mass H of water vapor added into the air tank 400 based on the initial mass B₀ of air, the mass B₁ of stored air stored in the air tank 400 of the mass of intake air, the amount D of water vapor of the air in the air tank 400, and the initial mass H₀ of water vapor in the air tank 400. Relationships between these parameters are expressed by Equation 6.

$$H = ( {B}_{0} + {B}_{1} ) \times D - {H}_{0} \qquad [ Equation 6 ]$$

At operation S712, the controller 800 may calculate the mass G of consumed water vapor of the consumed air. As shown in Equation 7, the mass G of consumed water vapor may be obtained by multiplying the mass B₂ of consumed air and the amount D of water vapor of the air in the air tank 400.

$$G = {B}_{2} \times D \qquad [ Equation 7 ]$$

The controller 800 may compute the mass F of water vapor, which is newly adsorbed by the adsorbent 300, based on the calculated values at operation S714. Specifically, the mass F of water vapor adsorbed by the adsorbent 300 may be calculated by subtracting the additional mass H of water vapor added into the air tank 400 and the mass G of consumed water vapor of the consumed air from the mass C of water vapor of the intake air before the adsorption. Relationships between these parameters are expressed by Equation 8.

$$F = C - H - G \qquad [ Equation 8 ]$$

At operation S716, the controller 800 may calculate the total mass F_{TOT} of water vapor contained in the adsorbent 300. The total mass F_{TOT} of water vapor may be acquired by adding the initial mass F₀ of water vapor and the mass F of water vapor newly adsorbed by the adsorbent 300.

At operation S718, the controller 800 is configured to compare the total mass F_{TOT} of water vapor of the adsorbent 300, which is computed in real time, with the threshold value TH, i.e., the maximum mass of water vapor that may be adsorbed by the adsorbent 300. In case the total mass F_{TOT} of water vapor is equal to or greater than the threshold value TH, the controller 800 requests the compressor system 100 to enter the regeneration mode at operation S720.

On the contrary, in case the total mass F_{TOT} of water vapor is less than the threshold value TH, the controller 800 updates the initial value at operation S722. In order to calculate the mass F_{TOT} of water vapor cumulatively contained in the adsorbent 300, the initial mass F₀ of water vapor is updated to the current total mass F_{TOT} of water vapor, the initial tank pressure Pₜ₀ is updated to the current pressure Pₜ of the air in the tank air tank 400, the initial tank temperature Tₜ₀ is updated to the current temperature Tₜ of the air in the air tank 400, and the initial tank dew point temperature Dₜ₀ is updated to the current tank dew point temperature Dₜ of the air in the air tank 400. Moreover, the initial mass B₀ of air in the air tank 400 is updated to a value obtained by adding the mass B₁ of stored air, which is stored in the air tank 400 from the mass B of intake air, into the current initial mass B₀ of air. In addition, the initial mass H₀ of water vapor in the air tank 400 is updated to a value obtained by adding the additional mass H of water vapor, which is added into the air tank 400, to the existing initial mass H₀ of water vapor in the air tank 400.

Additionally, the controller 800 newly measures the inlet dew point temperature Dᵢₙ, the outlet dew point temperature Dₒᵤₜ, the tank dew point temperature Dₜ of the air in the air tank 400, the pressure Pₜ of the air in the air tank 400, and the temperature Tₜ of the air in the air tank 400 and updates the values to the newly measured values at operation S724S.

After the values are updated, the controller 800 may perform operation S706 and steps subsequent to operation S706. As described above, the controller 800 may calculate the total mass F_{TOT} of water vapor of the adsorbent 300.

As illustrated in FIG. 9, according to an embodiment of the present disclosure, exit or termination of the regeneration mode may be determined during the regeneration mode of the compressor system 100.

With reference back to FIG. 6, at operation S602, the controller 800 may receive an operational signal of the compressor 200 from the compressor 200. Based on the receive operational signal, the controller 800 may identify which operating state the compressor system 100 is in.

At operation S604, the controller 800 may receive the operational signal from the compressor 200 such that the controller 800 may determine whether the compressor system 100 is in the compression mode or the regeneration mode. The controller 800 may perform operations subsequent to F1 in response to determining that the compressor system 100 is in the regeneration mode.

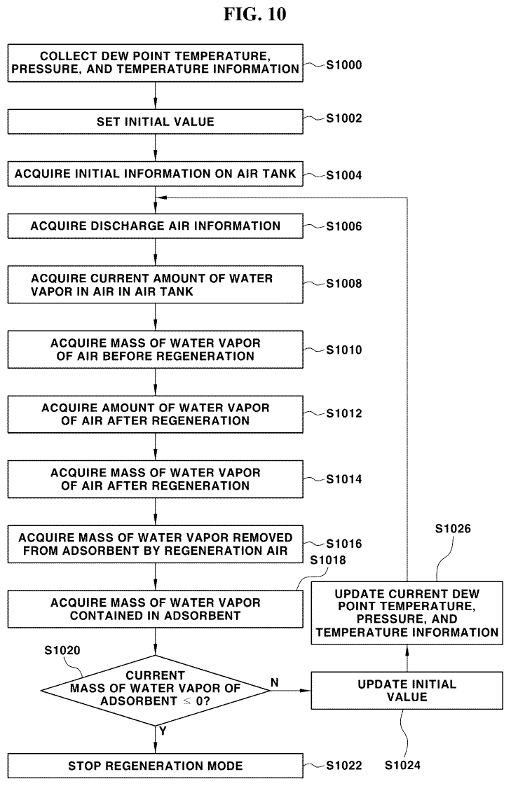

With reference back to FIG. 9, the controller 800 is configured to calculate, in real time, the saturation degree of the adsorbent 300 or the mass F_{TOT} of water vapor contained in the adsorbent 300 at operation S902 in response to determining the compressor system 100 is in the regeneration mode at operation S900. The mass F_{TOT} of water vapor of the adsorbent 300 may be determined based at least partially on the dew point temperature measured by the dew point meter 500, the pressure measured by the pressure sensor 700, and the temperature measured by the temperature sensor 600. A detailed calculation process is described with reference to FIG. 10.

The controller 800 is configured to determine whether the current total mass F_{TOT} of water vapor of the adsorbent 300 is 0 or less (S904). When the current total mass F_{TOT} of water vapor of the adsorbent 300 is 0 or less (YES at operation S904), it may be determined that the adsorbent 300 is completely dehydrated.

In contrast, when the current mass F_{TOT} of water vapor of the adsorbent 300 is greater than or exceeds 0 (NO at operation S904), the controller 800 goes back to operation S902 and continuously calculates the mass F_{TOT} of water vapor of the adsorbent 300. On the contrary, in case the current mass F_{TOT} of water vapor of the adsorbent 300 is 0 or less, the controller 800 stops the regeneration mode of the compressor 200 at operation S906.

With reference to FIG. 10, according to an embodiment of the present disclosure, a process of calculating the saturation degree of the adsorbent 300 or the mass F_{TOT} of water vapor contained in the adsorbent 300 may be performed as follows.

The controller 800 collects measurement information from the dew point meters 500, the temperature sensor 600, and the pressure sensor 700 at operation S1000. The controller 800 may collect, in real time, the inlet dew point temperature Dᵢₙ, the outlet dew point temperature Dₒᵤₜ, the tank dew point temperature Dₜ of the air in the air tank 400, the pressure Pₜ of the air in the air tank 400, and the temperature Tₜ of the air in the air tank 400.

At operation S1002, the controller 800 is configured to set an initial value based on the measurement information received at operation S1000. For example, the controller 800 may set the initial mass F₀ of water vapor of the adsorbent 300 to the mass of water vapor in the saturated state of the adsorbent 300, set an initial tank pressure Pₜ₀ to the pressure Pₜ of the air in the air tank 400 received at operation S1000, set an initial tank temperature Tₜ₀ to the temperature Tₜ of the air in the air tank 400 received in operation S1000, and set an initial tank dew point temperature Dₜ₀ to the tank dew point temperature Dₜ of the air in the air tank 400 received at operation S1000.

At operation S1004, the controller 800 is configured to acquire initial information on the air tank 400. The initial information on the air tank 400 may refer to the current state information on the air tank 400. Specifically, the initial information may refer to the state information on the air tank 400 before the compressed air in the air tank 400 is newly supplied to the adsorbent 300 in the regeneration mode. The initial information on the air tank 400 may include the initial mass B₀ of air in the air tank 400, the initial amount D₀ of water vapor in air within the air tank 400, and the initial mass H₀ of water vapor in the air tank 400.

Specifically, the controller 800 may calculate the initial mass B₀ of air in the air tank 400. The initial mass B₀ of air may be acquired by applying the initial tank pressure Pₜ₀, the initial tank temperature Tₜ₀, and the volume V1 of the air tank 400 to Equation 1.

Also, the controller 800 may acquire the initial amount D₀ of water vapor in air within the air tank 400. Specifically, the controller 800 may determine the initial amount D₀ of water vapor in air based on the initial tank dew point temperature Dₜ₀. The controller 800 may include the saturated water vapor curve in the form of a map or lookup table and acquire the initial amount D₀ of water vapor in air from the saturated water vapor curve by using the initial tank dew point temperature Dₜ₀.

The controller 800 may calculate the initial mass H₀ of water vapor in the air tank 400 based on the initial mass B₀ of air and the initial amount D₀ of water vapor in air. Specifically, the initial mass H₀ of water vapor may be acquired by the product of the initial amount D₀ of water vapor in air and the initial mass B₀ of air.

At operation S1006, the controller 800 is configured to acquire discharge air information on air discharged from the air tank 400 in the regeneration mode of the compressor system 100. The discharge air information may include information about the discharge air discharged from the air tank 400 through the adsorbent 300 in the regeneration mode and information about the sprayed air sprayed through the nozzle 16 from the air tank 400.

The mass R₁ of discharge air in the discharge air information on the air discharged from the air tank 400 may be determined based on the initial tank pressure Pₜ₀, the initial tank temperature Tₜ₀, the current pressure Pₜ, and the current temperature Tₜ. Specifically, the controller 800 may determine the mass R₁ of discharge air by relating the initial tank pressure Pro, the initial tank temperature Tₜ₀, the current pressure Pₜ, and the current temperature Tₜ using Equation 9. In other words, the mass R₁ of discharge air may be calculated by using the ideal gas equation (PV=mRT, where P is pressure, V is volume, m is mass, R is gas constant, and T is temperature).

$${R}_{1} = \frac{{P}_{t} \times V 1}{R \times {T}_{t}} - \frac{{P}_{t 0} \times V 1}{R \times {T}_{t 0}} \qquad [ Equation 9 ]$$

The controller 800 may calculate the mass R₂ of air sprayed through the nozzle 16 from the discharge air information on the air discharged from the air tank 400. For example, the mass R₂ of sprayed air may be determined by using characteristics of the flow choked in an outlet port 14b of a distributor 14. A mass flow rate \dot{m} in each of the outlet ports 14b may be determined using Equation 3, and the mass B₂ of consumed air may be calculated by multiplying the mass flow rate \dot{m} by a spray time for each of the outlet ports 14b or a spray time tₛ of the nozzle 16 connected to each of the outlet ports 14b.

The controller 800 may calculate the discharged air discharged to the outlet 240 from the air tank 400 through the adsorbent 300, i.e., the mass of regenerated air R₃ used to regenerate the adsorbent 300. The mass of regenerated air R₃ may be obtained by subtracting the mass of sprayed air R₂ from the mass of discharged air R₁.

At operation S1008, the controller 800 is configured to acquire the current amount D of water vapor in the air tank 400. The controller 800 may acquire the current amount D of water vapor in the air tank 400 from the saturated water vapor curve based on the tank dew point temperature Dₜ measured by the tank dew point meter 500c.

At operation S1010, the controller 800 acquires the mass of water vapor S₃ of the air before the regeneration. The mass of water vapor S₃ of the air before the regeneration may be determined based on the current amount D of water vapor in the air tank 400 and the mass of regenerated air R₃. Specifically, as shown in Equation 10, the controller 800 may compute the mass of water vapor S₃ of the air before the regeneration by multiplying the current amount D of water vapor in the air tank 400 and the mass of regenerated air R₃.

$${S}_{3} = D \times {R}_{3} \qquad [ Equation 10 ]$$

At operation S1012, the controller 800 may calculate the amount Q of water vapor of the air after the regeneration. The amount Q of water vapor of the air after the regeneration may be acquired by relating the outlet dew point temperature Dₒᵤₜ to the saturated water vapor curve.

At operation S1014, the controller 800 may acquire the mass of water vapor S₄ of the air after the regeneration. In particular, as shown in Equation 11, the mass of water vapor S₄ of the air after the regeneration may be calculated by multiplying the amount Q of water vapor of the air after the regeneration and the mass of regenerated air R₃.

$${S}_{4} = D \times {R}_{3} \qquad [ Equation 11 ]$$

Next, at operation S1016, the controller 800 may calculate the mass S of water vapor removed from the adsorbent 300 by regeneration air. The mass S of water vapor removed from the adsorbent 300 by the regeneration air may be calculated by subtracting the mass of water vapor S₃ of the air before the regeneration from the mass of water vapor S₄ of the air after the regeneration.

At operation S1018, the controller 800 may calculate the total mass F_{TOT} of water vapor contained in the adsorbent 300. The total mass F_{TOT} of water vapor may be acquired by subtracting the mass S of water vapor, which is removed from the adsorbent 300 by the regeneration air, from the initial mass F₀ of water vapor.

At operation S1020, the controller 800 is configured to determine whether the total mass F_{TOT} of water vapor of the adsorbent 300, which is computed in real time, is 0 or less. When the current total mass F_{TOT} of water vapor of the adsorbent 300 is 0 or less (YES at operation S1020), it may be determined that the adsorbent 300 is completely dehydrated.

When the current mass FTOT of water vapor of the adsorbent 300 is 0 or less, the controller 800 may determine that the adsorbent 300 is dehydrated, and the controller 800 may stop the regeneration mode of the compressor 200 at operation S1022.

When the current mass F_{TOT} of water vapor of the adsorbent 300 is greater than or exceeds 0 (NO at operation S1020), the controller 800 updates the initial value at operation S1024. In order to calculate the mass F_{TOT} of water vapor cumulatively contained in the adsorbent 300, the initial mass F₀ of water vapor is updated to the current total mass F_{TOT} of water vapor, the initial tank pressure Pₜ₀ is updated to the current pressure Pₜ of the air in the tank air tank 400, the initial tank temperature Tₜ₀ is updated to the current temperature Tₜ of the air in the air tank 400, and the initial tank dew point temperature Dₜ₀ is updated to the current tank dew point temperature Dₜ of the air in the air tank 400. In addition, the initial mass Bo of air in the air tank 400 is updated to a value obtained by adding the mass B₁ of stored air, which is stored in the air tank 400 of the mass B of intake air, to the current initial mass B₀ of air. Also, the initial mass H₀ of water vapor in the air tank 400 is updated to a value obtained by adding the additional mass H of water vapor, which is added to the air tank 400, to the existing initial mass H₀ of water vapor in the air tank 400.

Additionally, the controller 800 newly measures the inlet dew point temperature Dᵢₙ, the outlet dew point temperature Dₒᵤₜ, the tank dew point temperature Dₜ of the air in the air tank 400, the pressure Pₜ of the air in the air tank 400, and the temperature Tₜ of the air in the air tank 400 and updates the values to the newly measured values at operation S1026.

After the values are updated, the controller 800 may perform operation S1006 and steps subsequent to operation S1006. As described above, the controller 800 may calculate the total mass F_{TOT} of water vapor of the adsorbent 300.

According to the system and method of the present disclosure, because the flow rate of the air is determined by the temperature sensor and the pressure sensor, a flowmeter may be omitted. This is because the flow rate and the mass of water vapor are acquired in consideration of the air stored in the tank after passing through the adsorbent and the air sprayed through the nozzle because of the nature of the sensor cleaning system.

In addition, the system and method of the present disclosure may be applied even in a situation in which moisture of the air having passed through the adsorbent is not completely removed as a situation in which moisture of the air having passed through the adsorbent is not completely removed may occur.

The system and method of the present disclosure are configured to monitor both the adsorption situation and the situation in which the adsorbent is regenerated. Thus, the system and method of the present disclosure may consistently monitor the amount of water vapor contained in the adsorbent.

According to the present disclosure, it is possible to prevent the inefficiency and the deterioration in regeneration efficiency caused by a waste of the compressed air in consideration of the atmospheric state.

In addition, according to the present disclosure, it is possible to prevent damage to the component of the compressor system caused by the occurrence of condensate water.

The technical concepts of the present disclosure, which have been described above with respect to various embodiments, is not limited by the aforementioned embodiments and the accompanying drawings. IT should be apparent to those having ordinary skill in the art to which the present disclosure pertains that various substitutions, modifications, and alterations may be made without departing from the technical spirit of the present disclosure.

The technical concepts of the present disclosure have been described in detail with reference to certain embodiments thereof. However, it should be appreciated by those of ordinary skill in the art that changes may be made in these embodiments without departing from the principles and spirit of the disclosure, the scope of which is defined in the appended claims and their equivalents.

What is claimed is:

1. A compressor system comprising:
a compressor configured to draw in intake air and produce compressed air during a compression mode of the compressor system;
an adsorbent disposed such that the compressed air passes through the adsorbent, the adsorbent being regenerable by a regeneration mode of the compressor system;
an air tank configured to store the compressed air having passed through the adsorbent; and
a controller configured to determine a saturation degree of the adsorbent based on information on the intake air supplied to the compressor system or discharged air discharged from the compressor system.

2. The compressor system of claim 1, wherein the controller is configured to determine whether to perform or stop the regeneration mode based on the saturation degree of the adsorbent.

3. The compressor system of claim 1, further comprising:
an inlet dew point meter configured to measure a dew point temperature of the intake air;
an outlet dew point meter configured to measure a dew point temperature of the discharged air discharged from the compressor system in the regeneration mode; and
a tank dew point meter configured to measure a dew point temperature of stored air in the air tank.

4. The compressor system of claim 3, wherein the controller is configured to determine the saturation degree of the adsorbent based at least partially on measurement information of the inlet dew point meter, the outlet dew point meter, and the tank dew point meter.

5. The compressor system of claim 4, wherein the controller is configured to determine whether to perform the regeneration mode during the compression mode, based at least partially on initial information on the air tank, information on the intake air drawn during the compression mode, and spray information of the stored air in the air tank during the compression mode.

6. The compressor system of claim 4, wherein the controller is configured to determine whether to stop the regeneration mode during the regeneration mode based at least partially on initial information on the air tank, information on discharged air discharged during the regeneration mode, and spray information of the stored air in the air tank during the regeneration mode.

7. The compressor system of claim 1, wherein, in response to performing the compression mode, the controller stores the compressed air in the air tank, and wherein a nozzle is configure to spray the stored air from the air tank.

8. The compressor system of claim 1, wherein, in response to performing the regeneration mode, the controller is configured to direct the stored air in the air tank through the adsorbent.

9. A sensor cleaning system comprising the compressor system of claim 1.

10. A vehicle comprising the sensor cleaning system of claim 9.

11. A method of controlling a compressor system, the method comprising:
collecting, by a controller, state information of the compressor system;
determining, by the controller, at least one of a performance time point or a stop time point of a regeneration mode of the compressor system based on the state information; and
performing or stopping, by the controller, the regeneration mode of the compressor system in response to determining that the performance time point or the stop time point is reached.

12. The method of claim 11, wherein the state information includes an operating mode of the compressor system, and wherein the operating mode comprises:
a compression mode, wherein a compressor of the compressor system produces compressed air; and
a regeneration mode, wherein an adsorbent of the compressor system is dehydrated.

13. The method of claim 12, comprising:
in response to determining that the operating mode of the compressor system is the compression mode, acquiring initial information on an air tank that stores, as stored air, the compressed air;
acquiring information on intake air drawn into the compressor;
determining a saturation degree of the adsorbent based on the initial information on the air tank, the information on the intake air, and a current state of the air tank; and
determining whether to enter the regeneration mode of the compressor system based on the saturation degree.

14. The method of claim 13, comprising:
in response to determining that the saturation degree is equal to or greater than a preset threshold value, operating the compressor system in the regeneration mode; and
in response to determining that the saturation degree is less than the preset threshold value, operating the compressor system in the compression mode.

15. The method of claim 13, wherein the initial information on the air tank and the current state of the air tank are determined based on a pressure of the stored air in the air tank, a temperature of the stored air in the air tank, or a dew point temperature of the stored air in the air tank.

16. The method of claim 13, wherein the information on the intake air is determined based on a dew point temperature of the intake air, a temperature of the stored air in the air tank, a pressure of the stored air in the air tank, or a spray time of the stored air supplied to the outside from the air tank.

17. The method of claim 12, comprising:
in response to determining that the operating mode of the compressor system is the regeneration mode, acquiring initial information on an air tank that stores, as stored air, the compressed air;
acquiring information on discharged air discharged from the compressor system in the regeneration mode;
acquiring information on air before dehydration and air after dehydration in the regeneration mode;
determining a saturation degree of the adsorbent based on the initial information on the air tank, the information on the discharged air, and the information of the air before dehydration and the air after dehydration; and
determining whether to stop the regeneration mode of the compressor system based on the saturation degree.

18. The method of claim 17, comprising:
stopping the regeneration mode of the compressor system in response to determining that the saturation degree is 0 or less; and
continuing the regeneration mode of the compressor system in response to determining that the saturation degree greater than 0.

19. The method of claim 17, wherein the initial information on the air tank and a current state of the air tank are determined based on a pressure of stored air in the air tank, a temperature of the stored air in the air tank, or a dew point temperature of the stored air in the air tank.

20. The method of claim 17, wherein:
the information on the discharged air is determined based on a pressure of stored air in the air tank, a temperature of the stored air in the air tank, a dew point temperature of the discharged air, or a dew point temperature of the stored air in the air tank; and
the information on the air before dehydration and the air after dehydration is determined based on the initial information on the air tank and the information on the discharged air.
